(19) United States
(12) Patent Application Publication
(10) Pub. No.: US 2010/0187818 A1
(43) Pub. Date: Jul. 29, 2010

(54) Multi-process method of combined heat and power generation, biodiesel production, ethanol production, town gas production and methane production

(75) Inventor: William D. Bivins, Louisville, KY (US)

Correspondence Address: JAMES C. EAVES JR.;GREENEBAUM DOLL & MCDONALD PLLC, 3500 NATIONAL CITY TOWER, 101 SOUTH FIFTH STREET, LOUISVILLE, KY, 40202, US

(73) Assignee: Louisville Clean Energy, LLC

(21) Appl. No.: 12/657,536

(22) Filed: Jan. 22, 2010

Related U.S. Application Data
(60) Provisional application No. 61/205,838, filed on Jan. 23, 2009.

(51) Int. Cl. F02C 6/18; F02C 7/22; F01K 23/08

(52) U.S. Cl. 290/2; 60/39.12; 60/780

(57) ABSTRACT

The present invention relates to an energy efficient method of combined heat and power/combined-cycle electricity generation method and gasification method utilizing a multi-process method of producing, methane, biodiesel, and ethanol production. The waste heat from the combined heat and power generation/combined-cycle method and gasification method is utilized by these multiple methods in such a manner that the waste heat of each successive method serves directly as the heat reservoir for the succeeding method before it is reclaimed at the back-end of the combined-cycle method.

This application claims the benefit of U.S. Provisional Patent Application Ser. No. 61/205,838, filed Jan. 23, 2009, for MULTI-PROCESS METHOD OF COMBINED HEAT AND POWER GENERATION, BIODIESEL PRODUCTION, ETHANOL PRODUCTION, TOWN GAS PRODUCTION AND METHANE PRODUCTION.

### BACKGROUND OF THE INVENTION

(a) Field of the Invention

The present invention relates to a multi-process method that improves the efficiency of gasification, combined-cycle energy generation and comprises anaerobic digestion, biodiesel production, and ethanol fermentation as intermediate steps.

(b) Description of the Prior Art

Energy conservation and efficiency are vital to preserving our planet's rich natural resources and promoting a healthy environment. Towards those ends, various methods have been developed, and are in use today, that reduce our dependence upon greenhouse gas-producing fossil fuels.

“Ethanol Fermentation” produces an alcohol-based alternative fuel by fermenting and distilling starch crops that have been converted into simple sugars. Feedstock for this fuel includes sorghum, corn, barley, and wheat. Ethanol is most commonly used to increase octane and improve the emissions quality of gasoline. The combustion of ethanol creates very little pollution. However, traditional ethanol production suffers from inefficiencies in its use of energy. The energy return on energy invested for ethanol is close to 1:1. As ethanol is produced now, energy stored in useful forms (such as coal, natural gas, or ethanol) is burned to produce the 40,000 Btu of heat energy per gallon that ethanol production requires. This conversion of energy from a higher ordered state to a lower ordered state is accompanied by irreversible losses of energy to entropy. This means that it takes nearly as much energy (through natural gas based fertilizers, farm equipment, transformation from corn, and transportation) to create ethanol as the ethanol itself produces when combusted. Ethanol fermentation also produces wet distiller's grain as a byproduct.

“Biodiesel” is a diesel-equivalent produced from certain organic materials (such as vegetable oil), which can be used as fuel in unmodified diesel engines. Biodiesel is comprised of a mix of mono-alkyl esters of long fatty acid chains. The more common method uses methanol to produce methyl esters, as since it is the cheapest alcohol available. However, ethanol can be used to produce an ethyl ester biodiesel. The environmental benefits of biodiesel include a 78% reduction in carbon dioxide emissions. Because the carbon in biodiesel was recently removed from the atmosphere by plants, its release during the combustion of biodiesel only completes the carbon-cycle. In this way, the production of biodiesel through transesterification is considered to be an environmentally benign source of renewable fuel.

However, like ethanol fermentation, traditional biodiesel production suffers from inefficiencies in its use of energy. It takes 40,000-80,000 Btu of heat energy to produce one gallon of biodiesel, and traditional methods rely upon the burning of fossil fuels to produce this heat energy. Thus, like ethanol production, biodiesel production suffers losses to entropy as energy stored in useful forms (such as coal or methane) is converted to “scrap” or heat energy. Biodiesel production also creates large quantities of glycerin as a byproduct.

“Methane reactors” utilize the harnessed and contained, naturally occurring process of anaerobic digestion to produce biogas from biodegradable organic waste, such as sewage, leftover food, and animal waste. This biogas, a mixture comprised mostly of methane and carbon dioxide, is then burned to produce electricity. Methane reactors help to reduce global warming. The carbon within biogas was recently removed from the atmosphere by plants, and thus, the release of carbon during the combustion of biogas only completes the carbon-cycle. In this way, the production of biogas through anaerobic digestion is considered to be an environmentally benign source of renewable fuel.

In a combined heat and power/combined cycle power plant, a gas turbine generator produces electricity and the waste heat from that gas turbine is used to make steam which generates additional electricity via a steam turbine. An ideal steam turbine is considered to be an isentropic process, or constant entropy process, in which the entropy of the steam entering the turbine is equal to the entropy of the steam leaving the turbine. However, no steam turbine is truly “isentropic”, and typical isentropic efficiencies range from 20%-95% depending upon the turbine.

In sum, although “combined cycle” energy generation is a better alternative than simply venting the waste heat, it is inefficient in its “salvaging” of that waste heat. It loses excessive energy to entropy by forcing all of the heat energy back into a higher ordered state. And, the method suffers additional energy losses to entropy when that higher ordered energy is converted through future use back into heat energy.

### SUMMARY OF THE INVENTION

The present invention improves upon the energy efficiency of the combined heat and power/combined-cycle, methane reactor, biodiesel, and ethanol fermentation methods by combining these multiple methods such that waste heat from one method serves directly as the heat reservoir for a successive method. This method takes advantage of entropic losses to achieve the required temperature for each successive method, rather than wasting energy restoring all of the heat energy to a higher-ordered state. This method further increases energy efficiency by combining methods with complementary by-products and reagents.

In one embodiment, the present invention is a combined heat and power production system comprising (a) a methane reactor, wherein the methane reactor produces methane, (b) a combined heat and power unit, wherein the combined heat and power unit combusts methane from the methane reactor to produce electricity and heat, (c) a boiler including water, wherein the heat from the combined heat and power unit boils the water in the boiler to produce steam, (d) means for producing biodiesel, wherein steam from the boiler heats biodiesel feedstock to produce biodiesel, glycerol, and organic waste, (e) means for producing ethanol, wherein steam from the boiler heats mash, water, and a liquefaction enzyme to produce wet distiller's grain and ethanol, and (f) a steam turbine generator, wherein steam from the boiler and waste steam from the means for producing biodiesel and means for producing ethanol are used to produce electricity.

In another embodiment, the present invention is a method of combined heat and power production comprising the steps of (a) producing methane using a methane reactor, (b) combusting the methane produced by the methane reactor using a combined heat and power unit to produce electricity and heat, (c) using heat from the combined heat and power unit to boil water in a boiler to produce steam, (d) providing means for producing biodiesel, wherein steam from the boiler heats biodiesel feedstock to produce biodiesel, glycerol, and organic waste, (e) providing means for producing ethanol, wherein steam from the boiler heats mash, water, and a liquefaction enzyme to produce wet distiller's grain and ethanol, and (f) providing a steam turbine generator, wherein the steam from the boiler and excess steam from the means for producing biodiesel and means for producing ethanol are used to produce electricity.

### BRIEF DESCRIPTION OF THE DRAWINGS

A better understanding of the present invention will be had upon reference to the following description in conjunction with the accompanying drawings, wherein:

FIG. 1 presents a block diagram overview of the multi-process method and illustrates the flow of pressurized steam, byproducts and reagents between the complementary processes of Methane, Biodiesel, Methanol and Combined Heat and Power and gasification methods;

FIG. 2 shows a flow chart of a commonly used process for producing biodiesel from vegetable oil modified to show the exchange of by-products and reagents between this and the other complementary processes.

FIG. 3 shows a flow chart of a commonly used process for producing ethanol from grain mash modified to show the exchange of by-products and reagents between this and the other complementary processes.

### DETAILED DESCRIPTION OF THE PREFERRED EMBODIMENT

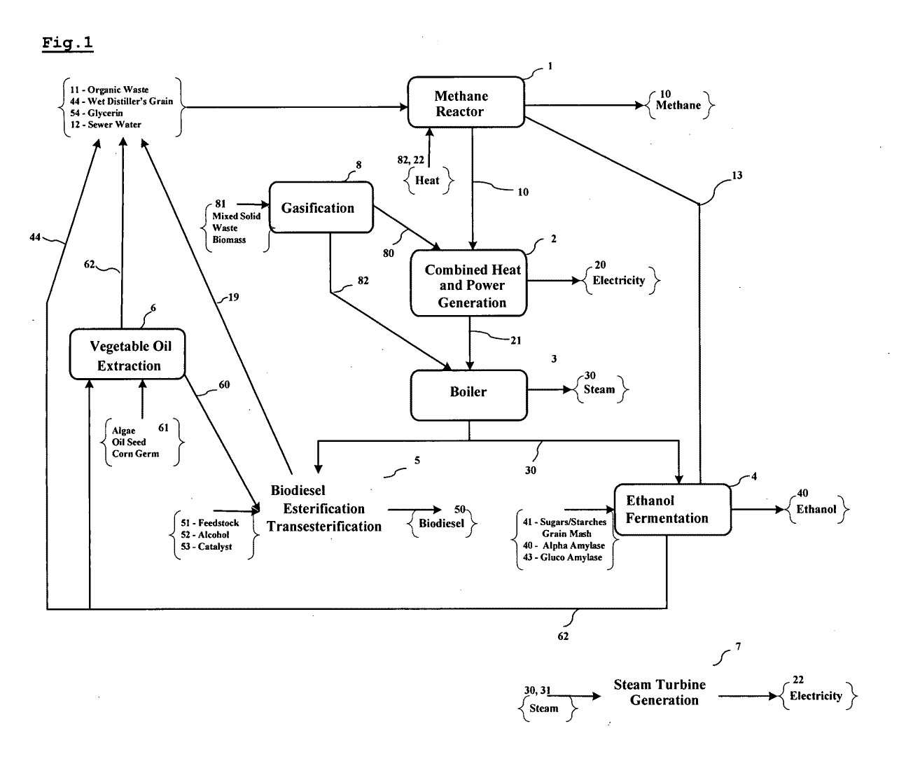

The present inventive processes are most easily understood by referring to FIG. 1 which is a flow chart overview of the multi-process method. The present method comprises the steps of anaerobic digestion of biomass 1, combined heat and power generation 2, steam generation 3, ethanol fermentation 4, and biodiesel production 5. The present invention combines these multiple methods such that waste heat from one method serves directly as the heat reservoir for a successive method.

Methane 10 is produced from the thermophilic anaerobic digestion of organic waste 11 originating from plants or animals, such as glycerin 54 or wet distillers grains 44. The organic waste is decomposed in a “methane reactor” 1 under controlled conditions. Lime is added, to maintain alkalinity. The temperature is preferably maintained above 150° F. This method produces an average 14,000 cubic feet of methane 10 per 1 ton of organic waste 11. This methane 10 is then used in a combined heat and power unit comprising a gas turbine generator and a thermal transfer device 2.

The methane 10 is first combusted in a combined heat and power gas turbine generator 2, producing electricity 20 and waste heat 21 at about 1000° F. The combustion of methane generates an average 1,000 Btu per cubic foot of heat energy. Some of this heat energy 21 is used to maintain the temperature of the methane reactor's contents between 150° and 185° F. Most of this heat energy 21 boils water to create about 900° F. steam 30 pressurized to about 175 p.s.i. This pressurized steam 30 will be used in the biodiesel 5 and ethanol 4 production methods, before it is reclaimed in process where it may be used to preheat the biodiesel feedstock or maintain constant fluidity of biodiesel feedstock storage tanks or used for the back-end of the combined-cycle power generation method 2.

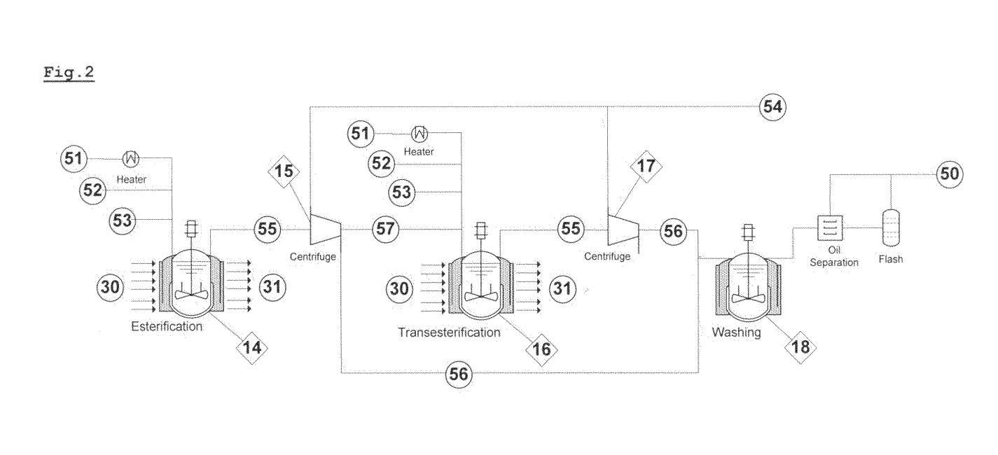

Referring now to FIG. 2, which depicts a means for producing biodiesel, the 900° F. pressurized steam 30 from the boiler 3 serves as the heat reservoir for the biodiesel production method 5. Waste heat 48 from ethanol fermentation cooling and/or waste steam 31 serves as the heat reservoir for preheating or maintaining storage temperature of the biodiesel feedstock. The production of biodiesel comprises combining alcohol 52 and a catalyst 53 with a feedstock 50 which may be selected from vegetable oils 60; animal fats; waste greases; and mixtures thereof.

Esterification is the conversion of Free Fatty Acids (FFA) to biodiesel. Esterification first occurs when the mixture of alcohol 52, catalyst (sulfuric acid) 53, and high FFA feedstock 51 are agitated in a first reactor 14 and heated by the steam 30 from the boiler to approximately 100 F. Remaining fraction of the feedstock 34 (monoglycerides and triglcerides) is feed into the transesterification reactor.

The decanting or centrifuging step promotes phase separation. The product stream 55 from this reactor 14 undergoes centrifugation 15 to remove glycerol 54 before the monoglycerides and triglycerides 57 enter a second reactor 16. The resulting biodiesel 56 enter a neutralization step 18.

Transesterification is the conversion of monoglycerides and triglycerides 57 to biodiesel. Transesterification first occurs when the mixture of alcohol 52, catalyst (methoxide) 53, product stream 57 and low FFA feed stocks 51 are agitated in a second reactor 16 and heated by the exhaust steam 30 from the boiler to approximately 100 F.

Additional alcohol 52 is added in this second reactor 16. Again, the product is heated by the boiler steam 30 and agitated and a transesterification reaction occurs again.

Following the transesterification reaction, the product is centrifuged 17, which removes additional glycerol 54 from the biodiesel 56. After separation from the glycerol 54, the biodiesel 56 enter a neutralization step 18 whereby acid 59 is added to neutralize any residual catalyst and to split any soap that may have formed during the reaction. Soaps will react with the acid 59 to form water soluble salts, which are mixed with water 58 and washed away. Following the wash process, the biodiesel 50 is subject to a vacuum flash process 19 removing any remaining water.

The production of biodiesel 50 consumes about 40,000-80,000 Btu and 0.1 gallon alcohol per gallon biodiesel produced. Its primary by-product is glycerol 54. The glycerol by-product of this method 54 and waste 11 is contributed to the feedstock of the methane reactor 1.

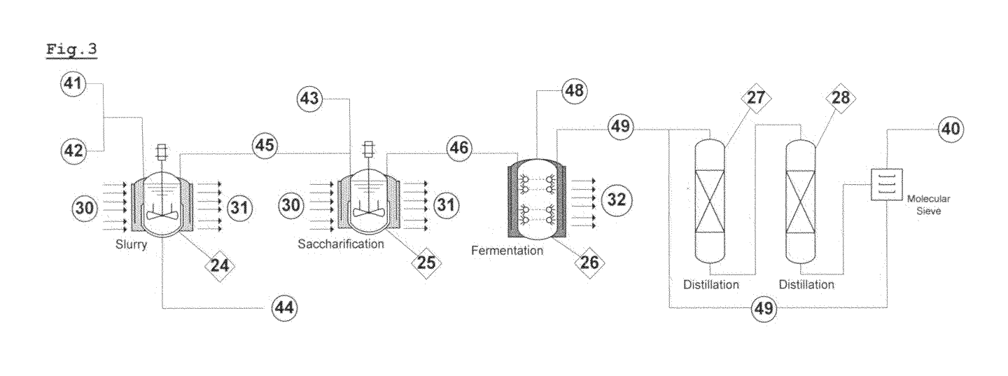

Referring now to FIG. 3, which depicts a means for producing ethanol, the 900° F. pressurized steam 30 from the boiler 3 serves as the heat reservoir for the ethanol fermentation method 4. This is a method for producing ethyl alcohol by thermophilic fermentation comprising cultivating of yeasts with sugar-containing substrates, cellulose-containing biomass or grain mashes 41. Grain mashes prepared from corn, wheat, rye, rice, barley are suitable and corn bran, wheat bran oat hulls and the like may also be used. Mashes prepared from cellulosic biomass; sweet sorghum, sugar cane and sweet beet are preferred.

The mashes 41 contain starches which are converted to sugars 46 in two stages, liquefaction and saccharification. Liquefaction, which breaks down the starches into complex sugars, occurs within a slurry tank 24 where the mash is mixed with water or gray water 13 and alpha-amylase 42, a liquefaction enzyme, and then cooked. The slurry is cooked at about 100°-120° F. using steam 30 from the boiler 3. The free starch will gelatinize as the temperature increases, forming into a hot slurry 45. This step produces the by products of wet distillers grain (whole stillage) 44, and waste steam 31.

Saccharification, which breaks down the complex sugars within the hot slurry 45 into simpler sugars, involves adding gluco-amylase 43, a saccharifying enzyme, and then cooking in an agitated tank 25. The hot slurry 45 is cooked at about 122°-140° F. using steam 30 from the boiler 3. This produces a mix of sugars 46 which may be used as a substrate for yeast cultivation and fermentation. The sugars 46, is transferred to the fermentation tank 26, mixed with yeast 48, and cooled to the optimum temperature (around 80°-90° F.). The yeast ferments the sugars into “beer” 49, which is solution of about 8-12% alcohol. This step produces the by products of CO₂, and waste heat 32.

The “beer” 49 is distilled into ethyl alcohol, or ethanol, using two separate columns, a stripper column 27 and a rectifying column 28. In the stripper 27 and rectifying 28 columns, steam 30 from the boiler heats the “beer” 49 to about 172° F., causing the ethanol to boil off. The ethanol is vapor captured and condensed to produce about 192-proof ethanol 40. The heat energy utilized to produce 1 gallon of ethanol is approximately 40,000 Btu.

The 500° F. waste steam 31 from the ethanol process serves as the heat reservoir used in the pretreating or maintaining storage temperature of the biodiesel feedstock or may also be used for the back-end of the combined-cycle power generation method 2. The waste steam 31 or excess steam 30 from boiler 3 is released into a steam turbine generator 7, completing the combined cycle electricity generation process.

Referring back to FIG. 1, the corn based wet distiller's grain 44, and/or with algae 61 and/or with corn bran, and/or with oil seed crop are subject to an oil extraction process 6. Means for extracting oil from wet distiller's grain oil seed and algae are known in the prior art. Generally, oil 60 is extracted from the wet distiller's grain 44 by contacting it with a normally gaseous inert solvent under supercritical condition at a controlled temperature and pressure. This process dissolves oil from the vegetable material into the solvent, and separates the oil-containing solvent from the resultant substantially oil-free vegetable residue 62.

The dissolved oil is then separated from the solvent by raising the temperature, or lowering the pressure, to separate vaporized solvent from the oil. The vaporized solvent may be liquefied and recycled. The oil-free residue 62 is then used as feedstock in the methane reactor process. The extracted oil 60 is used as a feedstock for the biodiesel process 5.

The foregoing detailed description is given primarily for clearness of understanding and no unnecessary limitations are to be understood from there for modifications can be made by those skilled in the art upon reading this disclosure and may be made without departing from the spirit of the invention and scope of the appended claims.

What is claimed is:

1. A combined heat and power production system comprising:
a. a methane reactor, wherein the methane reactor produces methane;
b. a combined heat and power unit, wherein the combined heat and power unit combusts methane from the methane reactor to produce electricity and heat;
c. a boiler including water, wherein the heat from the combined heat and power unit boils the water in the boiler to produce steam;
d. means for producing biodiesel, wherein steam from the boiler heats biodiesel feedstock to produce biodiesel, glycerol, and organic waste;
e. means for producing ethanol, wherein steam from the boiler heats mash, water, and a liquefaction enzyme to produce wet distiller's grain and ethanol;
f. a steam turbine generator, wherein steam from the boiler and waste steam from the means for producing biodiesel and means for producing ethanol are used to produce electricity.

2. The combined heat and power production system of claim 1, wherein the combined heat and power unit comprises a gas turbine generator and a thermal transfer device.

3. The combined heat and power production system of claim 1, wherein the methane reactor produces methane from the decomposition of the organic waste and the glycerol produced by the means for producing biodiesel.

4. The combined heat and power production system of claim 1, wherein the biodiesel feedstock comprises alcohol, a catalyst, and a selection from a group consisting of vegetable oils, animal fats, waste greases, or mixtures thereof.

5. The combined heat and power production system of claim 1, further comprising means for extracting oil from wet distiller's grain to produce oil and substantially oil-free residue, wherein the oil is incorporated into the biodiesel feedstock used by the means for producing biodiesel and wherein the substantially oil-free residue is incorporated into the organic waste used by the means for producing ethanol.

6. A method of combined heat and power production comprising the steps of:
a. producing methane using a methane reactor;
b. combusting the methane produced by the methane reactor using a combined heat and power unit to produce electricity and heat;
c. using heat from the combined heat and power unit to boil water in a boiler to produce steam;
d. providing means for producing biodiesel, wherein steam from the boiler heats biodiesel feedstock to produce biodiesel, glycerol, and organic waste;
e. providing means for producing ethanol, wherein steam from the boiler heats mash, water, and a liquefaction enzyme to produce wet distiller's grain and ethanol;
f. providing a steam turbine generator, wherein the steam from the boiler and excess steam from the means for producing biodiesel and means for producing ethanol are used to produce electricity.

7. The method of combined heat and power production of claim 6, wherein the combined heat and power unit comprises a gas turbine generator and a thermal transfer device.

8. The method of combined heat and power production of claim 6, wherein the step of producing methane using a methane reactor is producing methane by the decomposition of the organic waste and the glycerol produced by the means for producing biodiesel.

9. The method of combined heat and power production of claim 6, wherein the biodiesel feedstock comprises alcohol, a catalyst, and a selection from a group consisting of vegetable oils, animal fats, waste greases, or mixtures thereof.

10. The method of combined heat and power production of claim 6, comprising the further step of extracting oil from wet distiller's grain to produce oil and substantially oil-free residue, wherein the oil is incorporated into the biodiesel feedstock used by the means for producing biodiesel and wherein the substantially oil-free residue is incorporated into the organic waste used by the means for producing ethanol.
